(19) United States
(12) Patent Application Publication
(10) Pub. No.: US 2012/0023128 A1
(43) Pub. Date: Jan. 26, 2012

(54) DISCOVERY OF USER'S PREFERRED FILING CONVENTION FOR MEDIA ITEMS

(75) Inventor: Russell Sammon, San Francisco, CA (US)

(73) Assignee: Cisco Technology, Inc., San Jose, CA (US)

(21) Appl. No.: 12/842,536

(22) Filed: Jul. 23, 2010

(51) Int. Cl. G06F 17/30

(52) U.S. Cl. 707/769; 707/812; 707/805; 707/E17.044; 707/E17.014

(57) ABSTRACT

In one embodiment, a method of automatically determining a filing convention is provided. The method includes receiving a computer file path. The file path is associated with a digital media file. The method includes separating the file path into a plurality of fields. The separating is carried out using a field-separation module. The method further includes determining a filing convention based on the fields. The determining is carried out using a filing-convention-determination module. The method also includes storing the filing convention in a database.

### TECHNICAL FIELD

The present disclosure relates generally to media management, and more particularly, to the filing convention of media files.

### BACKGROUND

Rapid advancement in digital technologies has popularized digital media. A user can create digital media files including photos and videos with a standard digital camera/camcorder, and then transfer these digital media files to a computer for storage or further processing. The user may rely on a media manager program, such as ITUNES® or PICASA™ to help manage and organize these digital media files.

However, the media manager programs currently available on the market have some shortcomings. For example, each user may use a different filing convention—the way that user organizes his or her files—than other users. Useful information about the files may be embedded in the user's filing convention. Existing media manager programs may not be able to automatically determine each user's filing convention. Consequently, these media management programs may not extract all the available information from each user and may not fully assist the user in organizing the files later. In addition, some of the existing media management programs have their own built-in default filing conventions. If a user realizes that his/her own filing convention does not match the filing convention of the media management program, it may discourage that user from using the media manager program.

Therefore, although existing media management programs have been generally adequate for their intended purposes, they have not been entirely satisfactory in every aspect.

### BRIEF DESCRIPTION OF THE DRAWINGS

FIGS. 1-3 are respective diagrammatic views of example folder hierarchies for three different example users.

FIG. 4 is a diagrammatic view of an example file path including fields and separators.

FIG. 5 is a flowchart illustrating a method to automatically determine a filing convention according to one embodiment.

FIG. 6 is a simplified diagrammatic view of a system that may be used to carry out the automatic filing convention determination method illustrated in FIG. 5 according to one embodiment.

### DESCRIPTION

### Overview

One embodiment of the present disclosure involves a method that includes: receiving a computer file path, the file path being associated with a digital media file; separating, by a field-separation module, the file path into a plurality of fields; determining, by a filing-convention-determination module, a filing convention based on the fields; and storing the filing convention in a database.

One embodiment of the present disclosure involves an apparatus that includes a non-transitory, tangible computer readable storage medium storing a computer program. The computer program has instructions that when executed, carry out: separating a file path into a plurality of fields; determining a filing convention based on the fields; and storing the filing convention.

Another embodiment of the present disclosure involves a system that includes: a process engine that separates a file path into a plurality of fields and determines a filing convention based on the fields; a database that stores the filing convention; and an interface that allows the process engine to communicate with a user.

### DESCRIPTION OF EXAMPLE EMBODIMENTS

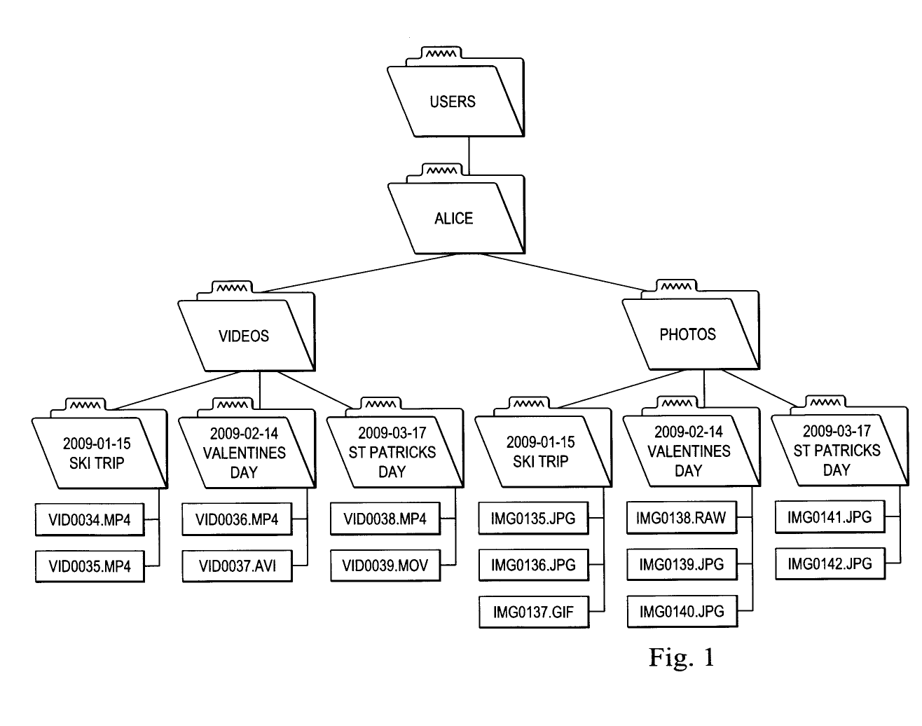

FIGS. 1-3 are diagrammatic views of folder hierarchies of example users Alice, Bob, and Carly, respectively. These folder hierarchies help illustrate each user's filing convention, which may also be referred to as naming convention. The filing convention specifies how a user organizes his/her files. Referring to FIG. 1, example user Alice may put all of her digital videos into a folder (also referred to as directory) named “Videos” and all of her digital photos into another folder named “Photos”. Within the “Videos” folder and the “Photos” folder, Alice may create subfolders “2009-01-15 Ski Tip”, “2009-02-14 Valentines Day”, and “2009-03-17 St Patricks Day”.

Various digital video files may be placed within each of these subfolders in the “Videos” folder, and various digital photo files may be placed within each of these subfolders in the “Photos” folder. These digital video and photo files may not be individually named. Rather, the digital video files may each have a “VID” prefix followed by a numerically incrementing string and an appropriate digital video file extension such as “.MP4”, “.AVI” or “.MOV”. The digital video files may each have an “IMG” prefix followed by a numerically incrementing string and an appropriate digital photo file extension such as “.JPG”, “.GIF” or “.RAW”. The file names of the digital video and photo files may be generated by the digital camera/camcorder by default. Thus, Alice may be organizing her digital videos and photos by the particular event associated with the video and photo files, instead of adding a thorough description in each file's name.

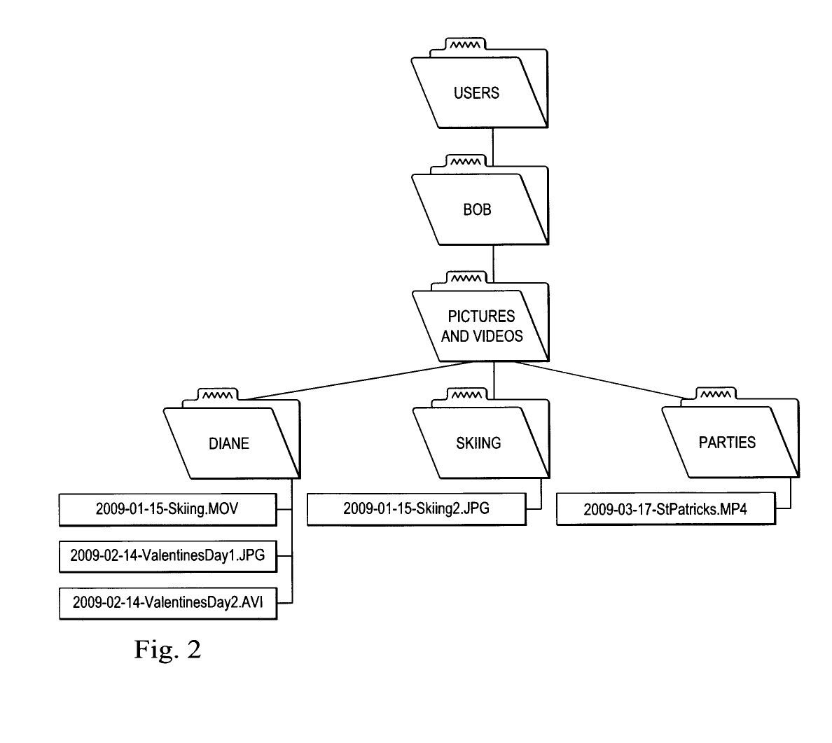

Referring now to FIG. 2, example user Bob may put all of his digital videos and photos into a consolidated folder named “PicsAndVideos”. Within this folder, Bob may then create subfolders corresponding to individual events or persons. For example, subfolders “Diane”, “Skiing” and “Parties” may be placed within the consolidated folder “PicsAndVideos”. Within each of these subfolders, Bob may also name the files based on the date they were created and a short description of the file itself.

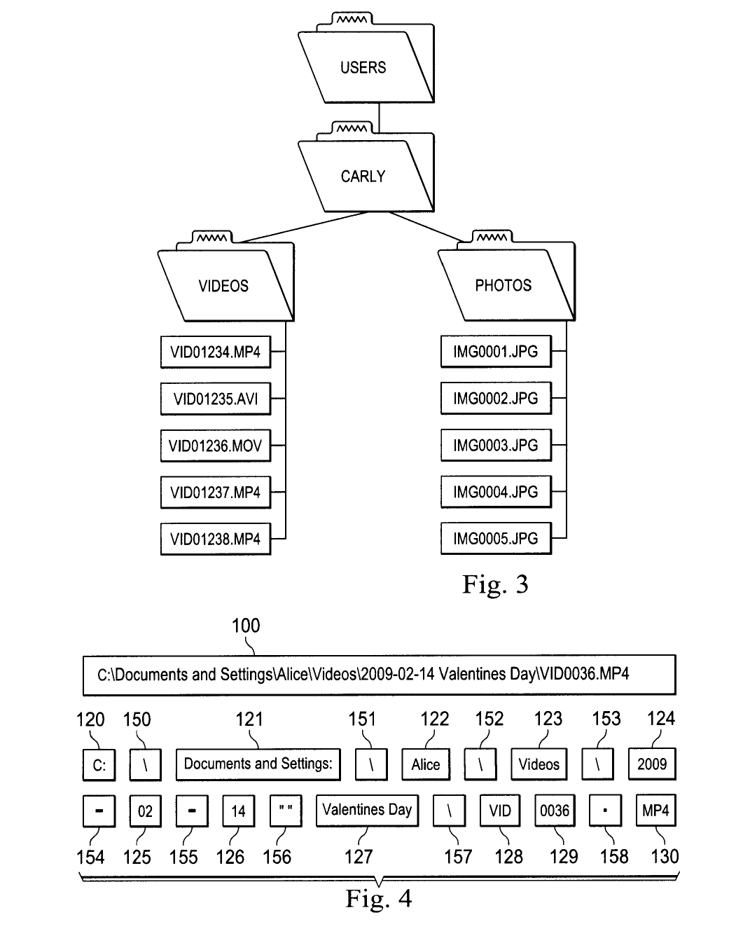

Referring now to FIG. 3, example user Carly may put all of her digital video files into a folder named “Videos” and all of her digital photos into a folder named “Photos”. She may not create subfolders within either the “Videos” folder or the “Photos” folder. Nor does she individually name each file in these two folders. Thus, if Carly wants to sort these files, she would rely on metadata associated with each file, such as modified date, file type, or tags.

FIGS. 1-3 illustrate only three example folder hierarchies. Each of these folder hierarchies demonstrate the way the user chooses to organize his/her files, which is his/her preferred filing convention. Many other filing conventions may exist but are not discussed in detail herein for purposes of simplicity and clarity. Each user may have one or more preferred filing conventions, for example different filing conventions for different folders. If a media manager program does not recognize and accommodate the user's preferred filing conventions, the user may be discouraged from using that media manager program. Also, it may be desirable for a media manager program to automatically determine the filing conventions of the user, because useful information about the files may be extracted in this identification process. The extracted useful information may be stored and may help improve the functionality of the media manager program. This will be discussed later in more detail.

The determination of a filing convention involves file paths. Each file path identifies the location of a file on a file system. The file path may include a file name, one or more folder names, and one or more path separators (e.g., “/” for an UNIX®-based operating system, and “\” for a WINDOWS®-based operating system). The file path may be an absolute path, in which case it is a single string pointing to the exact location of the designated file. An example of an absolute file path may be “C:\Documents and SettingsVoeUser\MyVideos\Party.MP4”. The file path may also be a relative path, in which case the location of the designated file is shown relative to a current directory. An example of a relative file path may be “../videos/skiing.MOV”. The file path may be file system or operating system dependent. For example, certain characters may be prohibited from particular file systems. The file path may also include symbolic links or shortcuts (e.g., “˜/My Videos” or “Shortcut to My Movies/Birthday.WMV”).

Referring to FIG. 4, an example file path 100 is illustrated. The example file path 100 may contain a word string “C:\Documents and Settings\Alice\Videos\2009-02-14Valentines Day\VID0036.MP4”. The file path 100 may include a plurality of fields 120-130 that are separated by a plurality of separators 150-158. The fields 120-130 and the separators 150-158 may also be referred to as “components” of the file path 100.

The fields 120-130 may each be a substring of the file path 100 and each correspond to a piece of information or tag of the designated file, the designated file being the digital video file VID0036.MP4 in this case. The field 120 contains the substring “C:”, which may define a computer drive name. The fields 121-123 respectively contain the substrings “Documents and Setting:”, “Alice”, and “Videos”, which may each define a folder name. The fields 124-126 respectively contain the substrings “2009”, “02” and “14”, which may each define a different portion of a folder name. The field 127 contains the substring “Valentines Day”, which defines a folder name. The fields 128-130 respectively contain the substrings “VID”, “0036”, and “MP4”, which each define a different portion of a file name.

These substrings contained in each of the fields 120-130 may also be referred to as field values. Meanwhile, field names may be assigned for the fields 120-130. Field names may be identifiers that are useful in determining the meaning of the fields 120-130. To provide some examples, the field name for the field 122 (“Alice”) may be a “person”. The field name for the field 123 (“Videos”) may be a “file type”. The field name for the field 127 (“Valentines Day”) may be an “event”. The field name for the field 130 (“MP4”) may be a “file extension”. Also, a single field name “date” may be assigned to the fields 124-126 collectively, or separate field names “year”, “month” and “day” may be assigned to the fields 124-126 individually.

It is understood that the fields 120-130 are merely example fields. A file path may include many different other types of fields, such as captions (e.g., “Fido eating my shoe”), locations (e.g., “Hawaii”), subjects (e.g., “Trains”), creators (e.g., “My Movies”), actions (e.g., “Skiing” or “Biking”), or other user-defined tags.

The separators 150-158 may include characters or strings that are used to separate the fields 120-130 within the file path 100. For example, the separators 150-153 and 157 may each be a character “\” (backslash), the separators 154-155 may each be a character “-” (hyphen), the separator 156 may be a character “ ” (space), and the separator 158 may be a character “.” (dot). Thus, it can be seen that a single file path (such as the file path 100) may have multiple separators.

It is also possible that two fields may not be separated by a separator. For example, the fields 128 (VID) and 129 (0036) are not separated by a separator. The separators 150-158 are merely examples and are not meant to be limiting. Other examples of separators may include “/” (forward slash), “_” (underscore), “,” (comma), “˜” (tilde), “<” (less than sign), “>” (greater than sign), “=” (equal sign), “+” (plus sign), “*” (asterisk), “@” (at), “#” (number sign), “:” (colon), “;” (semicolon), or “|” (vertical bar). The separators may vary according to the file system or operating system, because some separators are forbidden in file paths on a certain operating system but may be available on others.

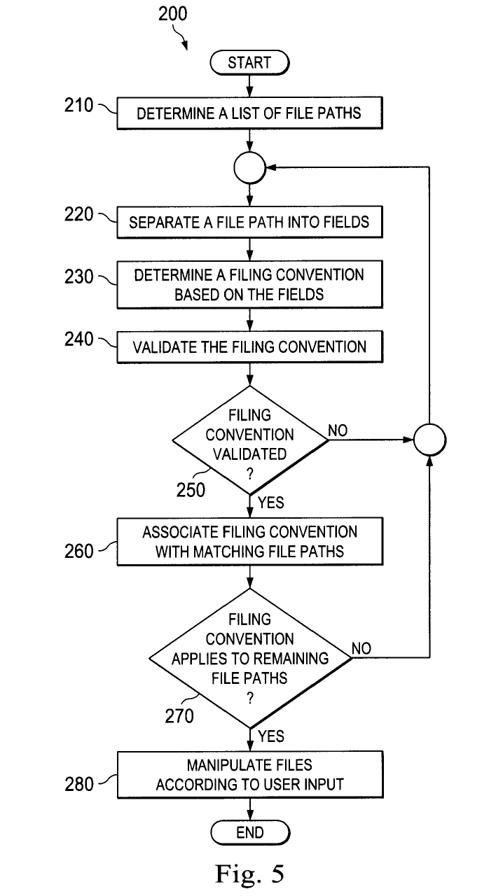

FIG. 5 is a flowchart that illustrates a method 200 of automatically determining a filing convention according to one embodiment. The method 200 may begin with block 210, in which a list of file paths is determined. The execution of the block 210 may involve searching a file system (which may include a server or a local computer) of all file paths. In that case, the file path for every single file may be returned by the search. The execution of the block 210 may alternatively be limited to only search for file paths that match a predefined pattern, or are located in a specified directory. For example, the file system may be scanned to return a list of all file paths that include a specific word, such as the word “video”. In that scenario, the two following example file paths may be returned by the search: “C:\My Documents\Video0234.WMV” and “C:\My Videos\Buster.AVI”.

As another example, the file system may be searched to return all files that have the same extension, such as the extension “.JPG” or “.AVI”. A list of desired file extensions may be maintained by a database. The database may be implemented on a network, or may be implemented locally, such as on an end user's computer hard drive or even computer memory. The database can also be centrally managed by a network administrator or by an end user. The list of desired file extensions may determine which type of files can be opened or searched. As such, the network administrator or the end user can edit, add, or remove file types on the search list. In other words, the network administrator or the end user can each specify which file types should be searched.

Carrying out the search may involve running a process that lists the contents of one or more directories on the target file system. For example, if the target file system to be searched is UNIX® based, a search command “ls-r” may be used to list the contents of directories. Carrying out the search may also involve accessing an index of files on the file system. The WINDOWS® Search index or the Google Desktop Search™ index may be accessed. The result of the search may be stored in the same database that stores the file extensions discussed above, or may be stored in a separate but similar database.

The method 200 may continue with block 220 in which a file path is separated into fields. Once a list of file paths have been identified, a “regular expression” program or utility may be used to separate any of the file paths into a plurality of fields. As an example, the “regexp” utility for a WINDOWS®-based operating system may be used to carry out the separation of file paths. As discussed above in association with FIG. 4, adjacent fields may be separated by various types of separators, and sometimes with no separator in between. What constitutes a separator may vary. For example, the character “-” (hyphen) may constitute a separator between numbers (for dates), but may not constitute a separator between words (for hyphenated words).

There may be multiple different ways to separate a file path into fields. Using the example file path 100 of FIG. 4 to illustrate, the field 127 containing the substring “Valentines Day” may be further separated into fields that contain substrings “Valentines” and “Day”, respectively. Meanwhile, the fields 124-126 may be joined together along with separators 154-155 to form a single field that contains the substring “2009-02-14”. Therefore, each file path may be separated into a plurality of different combinations of fields and separators.

There may be a variety of methods to identify different types of fields, as illustrated in Table 1 below:

TABLE 1

| | | Method of Identifying |
|---|---|---|
| Field Name | Example Field Values | Field |
| Date/Time | “2010-03-17”, | Regular expression |
| | “Mar-17-10”, | See ISO 8601 |
| | “3:45pm” | |
| Known Tags (e.g., | “Adam”, “Bob”, | Lookup in at least one |
| names of people, | “St Patricks Day”, | dictionary: |
| locations, actions, | “Skiing”, | Standard list of tags |
| events) | “NYE”, | (e.g., including |
| | “New Year's Eve”, | common names, |
| | “Birthday” | holidays, actions |
| | | etc). |
| | | User-specific tags. |
| | | Ex: user may have |
| | | specified his own |
| | | tags in addition to |
| | | the standard list |
| System Path | “C:\Documents and | May be regexp based on |
| | Settings\Adam\My | operating system (e.g., |
| | Documents\” | different for |
| | | WINDOWS ® |
| | | and MAC ®) |
| | | May be a leftover field |
| | | after other fields have |
| | | been identified. |
| Prefix | “VID”, “IMG”, | Dictionary lookup: List of |
| | “PIC”, “DSC” | standards prefixes used by |
| | | major camera and |
| | | camcorder manufacturers. |
| ID Number | “014352” | Regexp. Often associated |
| | | with a known prefix. |
| File suffix | “.MP4”, “.JPG”, | Regexp |
| | “.AVI” | |
| Media type | “Movies”, | Dictionary lookup: List of |
| | “My Movies”, | default folder names |
| | “Videos”, | provided in operating |
| | “My Pictures” | systems, as well as |
| | | tags/standards established |
| | | by the user |

Table 1 includes a left column, a middle column, and a right column. The left column is a list of example field names. The middle column is a list of example filed values corresponding to each of the field names in the left column. The right column is a list of methods of identifying the corresponding field in the left column. Table 1 also includes a plurality of rows, each row being associated with a different field.

The fields may be identified in different orders. For example, the file path may be parsed in a left-to-right manner or alternatively in a right-to-left manner. Further, filters used to identify fields may be applied in a particular order. For example, dates may be identified before ID numbers (which may be sequence numbers). As another example, known prefixes (such as VID or IMG) may be identified before numbers. Also, the dictionaries and other methods of identifying fields may be updated via a software update process, for example downloaded from a web server.

The method 200 may continue with block 230 in which a filing convention for a user may be determined based on the fields identified. Since it is possible for a user to employ different filing conventions for different directories, the filing convention determination process may be performed on a directory-by-directory basis.

Several approaches may be used to determine the filing convention. For example, one approach may involve a consensus determination. In more detail, after a file is separated into fields (performed by the block 220 discussed above), at least one potential filing convention may be estimated for this file. This estimation may be repeated for all the files in a given directory, which may return a plurality of filing conventions. The number of file paths that correspond to each filing convention is tallied. Next, the filing convention with the most tallies—the consensus choice—is selected as being the filing convention that best represents the files in the given directory. As another example of determining the filing convention, a list of known filing conventions may be retrieved (for example from a database) and matched with each file in a directory. The matching results may show which known filing convention may be the best match for all the files, and thus that filing convention may be selected as being the most representative.

In both of the example approaches to determine filing conventions, a subset of files may have file paths that do not match the most representative filing convention. In that case, either of these example approaches may be repeated only for this subset of non-matching files. This may return a second most representative filing convention. If there is still a further subset of files that fail to match the second most representative filing convention, the process may repeated again to return a third most representative filing convention, and the fourth most representative filing convention, etc., until the list of non-matching files is exhausted. It is also understood that the block 230 (determining filing convention) may be performed before, during, or after the block 220 (separating file paths into fields).

The method 200 may continue with block 240 in which the filing convention selected by the block 230 is validated. For example, a validation score may be calculated for each of the filing conventions picked by the block 230. The validation score may be calculated based on the number of matching file paths associated with each filing convention. The number of matching file paths may be further categorized for a particular directory, for a particular file type, or for a particular time period.

The method may then proceed to a decision block 250 to determine whether the validation score for each of the filing conventions passes a predetermined threshold value. For example, the predetermined threshold value may specify a validation score of at least 90 (90% of files are matching files). In other words, if a filing convention matches more than 90% of the file paths, it may be validated. Otherwise, the filing convention may be discarded, and the method 200 loops back to repeat the execution of block 220 again.

If a filing convention is validated by the decision block 250, the method 200 may proceed to block 260, in which a filing convention is associated with file paths that match the filing convention. In more detail, once a filing convention is validated by the decision block 250, the filing convention is stored in a database, either locally on a user's computer or remotely on a network. Listed below is a Table 2 that displays an example filing convention database:

TABLE 2

| Filing | |
|---|---|
| Convention ID | Filing Convention |
| FC-0001 | <SystemPath>\<MediaType>\<IdNumber>.</Suffix> |
| FC-0002 | <SystemPath>\<Date><EventName>\<Prefix><IdNumber>.<Suffix> |
| FC-0003 | <SystemPath>\<EventName>\<Prefix><IdNumber>.<Suffix> |
| FC-0004 | <SystemPath>\<MediaType>\</EventName>\<TagList>.<Suffix> |

Table 2 may include two columns. The column on the left lists the filing convention identification (ID) numbers, each filing convention being associated with a unique ID number. The column on the right lists the validated filing conventions, which may each include a plurality of fields (e.g., <SystemPath> or <Prefix>) separated by separators (e.g., “\” or “.”). The filing convention database may be constantly updated as new filing conventions are learned (or returned by the execution of blocks 210-250).

A list of file paths that need to be associated with the filing conventions may also be maintained in a local or remote database. Listed below is a Table 3 that displays an example lists of file paths that need to be associated:

TABLE 3

| | Filing | | | |
|---|---|---|---|---|
| File Path | Convention | Date | EventName | IdNumber |
| C:\Users\Bob\Videso\3414.M | FC-0001 | | | 3414 |
| P4 | | | | |
| C:\Users\Adam\Videos\15764 | FC-0001 | | | 15764 |
| .AVI | | | | |
| C:\Users\Adam\Videso\15765 | FC-0001 | | | 15765 |
| .MP4 | | | | |
| D:\Users\Bob\2009-02-01 | FC-0002 | 2009- | Birthday | 1234 |
| Birthday\VID1234.MOV | | 02-01 | | |
| D:\Users\Adam\2010-Feb-14 | FC-0002 | 2010- | Valentines | 2347 |
| Valentines | | 02-14 | Day | |
| Day\VID2347.MP4 | | | | |
| C\Users\Bob\Videos\Birthday\ | FC-0004 | | Birthday | |
| Cake.MOV | | | | |
| C\Users\Bob\Videos\Birthday\ | FC-0004 | | Birthday | |
| Candles.MOV | | | | |

Table 3 includes 7 rows (excluding the headers), each row corresponding to a different file path. Table 3 also includes 5 columns. The “File Path” column lists the file paths. The “Filing Convention” column lists the ID numbers associated with the filing conventions. The rest of the columns are example fields belonging to their respective filing conventions. As an example, and referring to Table 1, the filing convention with the ID number FC-0002 includes the fields <Date>, <EventName>, and <IdNumber>, which are also listed in Table 3. Note that the columns such as “Date” or “EventName” are just example columns, and additional columns corresponding to other fields (e.g. <Prefix> or <Suffix>) of a filing convention may also be included in Table 3 and the file path database.

With reference to Table 3, the file paths occupying rows 1-3 are associated with the filing convention with the ID number of FC-0001, because these file paths match the filing convention FC-0001. Using the filing convention “C:\Users\Bob\Videso\3414.MP4” to illustrate why these file paths match the filing convention FC-0001, “C:\Users\Bob” may constitute the field <SystemPath>, “Bob” may constitute the field <MediaType>, “3414” may constitute the field <IdNumber>, and “MP4” may constitute the field <Suffix>. Similarly, the file paths occupying rows 4-5 are associated with the filing convention with the ID number of FC-0002, and the file paths occupying rows 6-7 are associated with the filing convention with the ID number of FC-0004.

The method 200 may then proceed to a decision block 270 to determine whether the filing convention applies to the remaining file on the list of files to be associated. If no, then the method 200 may loop back to before the block 220 is executed, and then repeat the process described above again for the file paths that do not match the filing convention. If yes, then the method 200 may continue to block 280. It is understood that in some embodiments, the decision block 270 may be combined with, or executed as a part of, the decision block 250.

As the method proceeds to block 280, one or more filing conventions preferred by a user have been determined. Now, the user may be offered a plurality of options to manipulate files. One example option may be that the user may be allowed to specify a group of files to be added to a central library using any one of the user's preferred filing conventions. The specified group of files may be imported from a camera/camcorder or may be downloaded off the internet. The user may also be given the option of automatically organizing any new files or digital media according to the newly determined user filing convention or other filing convention, such as a previously used filing convention, selectable by the user.

Another example option may be that the user is allowed to convert or copy the files in a folder from one filing convention to another. This option may be useful for several reasons. For example, the user may have initially set up his files so that half of the files use one filing convention, and the other half of the files use a different filing convention. Now the user wishes to use one single filing convention for all of his files, which he/she can easily do at this point. This option may also provide flexibility to the user who may have changed his/her mind about what his/her preferred filing convention is. This may happen when the user capture only photos in the past, but now captures both photos and videos, or that the user now tags every photo with meta-information, which was not done before. Another flexibility offered by this option may be ease of file backup. The user may easily select the files that need to be backed up, and also specify the filing convention for these files as they are backed up.

The user may also be offered an option to upload information about such user's filing conventions to a server, for example a server owned and hosted by a company that makes the media management program of this application. This option may allow the company to continuously improve the media management program by adding new filing conventions to the list of known filing conventions. To ease users' privacy concerns, this uploading process may be carried out anonymously, or in an abstracted or aggregated fashion.

Other options may be offered in the block 280, but for the sake of simplicity, they are not discussed in detail herein. In one embodiment, the method 200 may end after the execution of the block 280. However, in other embodiments, the method 200 may proceed to additional blocks (not illustrated) after the execution of the block 280.

Existing media management programs do not have the capability to automatically determine a filing convention based on a list of file paths. In contrast, the media management program discussed in this application can automatically determine one or more user-preferred filing conventions based on a list of file paths associated with the user's files. As such, the media management program of this application has certain advantages, it being understood that other embodiments of the media management program may have different advantages, and that no particular advantage is required for any embodiment of the media management program discussed herein.

One of these advantages is that useful information regarding the files themselves can be extracted through the automatic filing convention determination process. For example, the following information may be gleaned through the directory names or file names (both of which are portions of file paths):
when was the file created (e.g., a directory containing a “date” field having a field value of “2-14-2010”).
where was the file created (e.g., a directory containing a “location” field having a field value of “Hawaii”).
what event was associated with the file (e.g., a directory containing an “event” field having a field value of “skiing”).
who was associated with the file (e.g., a directory containing a “person” field having a field value of “Tom”).
what type of file is it (e.g., a directory containing a “file type” field having a field value of “VID”).

In addition, the media management program of this application may allow “tags” or “labels” to be added as fields, which may also be extracted by the method 200 described above. Some tags may be embedded in the files themselves when the files were originally created. Examples of these tags may include resolution, frame rate, bit rate, sample rate, GPS coordinates, size, etc. Other tags may be added by a user, which may occur well after the file was created. Examples of these tags may include author, caption, title, category, keywords, or comments.

All the information (including tags) extracted through the automatic filing convention determination process may be stored in a database. Consequently, each entry corresponding to a digital media file in the database may contain useful information regarding that file. This holds true regardless of whether the user intentionally provided the information through tags or unintentionally provided the information through his/her naming schemes used in the filing convention.

At this point, the database may be used to perform an array of file sorting and organizing tasks, including tasks to carry out the options of the block 280 (FIG. 5). For instance, a selected group of files may be renamed. The group of files may come from different subsets that correspond to different directories/folders, or even from different users. Also, the group of files may have originally been filed away using different filing conventions, such as the examples shown in FIGS. 1-3. Using the media management program of this application, all the files in the group may be renamed so that they all have the same filing convention. The filing convention may be selected from a list of predefined filing conventions, or it may be user-specified (e.g., the user may decide which fields come before or after other fields).

In addition to renaming files, a user may also be able input any combination of query terms into the database, so that the database may perform the corresponding task. For purposes of illustration, the following example queries are listed below:
return a list of all JPG image files taken after the year 2003;
return a list of all video files that are less than 1 minute long;
return a list of all audio files associated with the artist named U2 from album created before 1995;
play all videos from June 2009 that were captured on a Sony Camcorder in high definition (720p) video that are tagged as “birthday” and “Alice” but do not include the tag “Bob”;
export all image files authored by “Carly” to FACEBOOK® or another social networking site;
delete all video and image files tagged with “ex-girlfriend”.

From the above discussions, it can be seen that the media management program of this application may greatly assist the user in organizing his/her files.

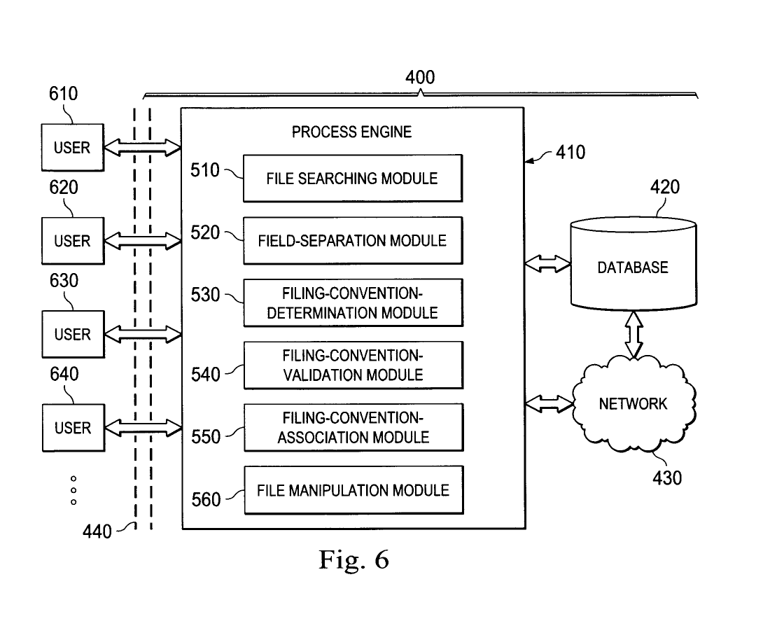

FIG. 6 shows a diagrammatic view of a system 400 that may be used to carry out the method 200 of FIG. 5. The system 400 may include a process engine 410, a database 420, a network 430, and an interface 440. The process engine 400 may be coupled to the database 420 and the network 430, and the database 420 may be coupled to the network 430 as well.

The process engine 410 may include a file-searching module 510, a field-separation module 520, a filing-convention determination module 530, a filing-convention validation module 540, a filing-convention association module 550, and a file manipulation module 560. Each of these modules 510-560 may include a computer hardware device encoded with software programs that may be executed to perform specific tasks. The computer hardware device of each of the modules 510-560 may include a non-transitory, tangible computer readable storage medium (e.g., a hard disk or a compact disk) where the software programs are stored. The modules 510-560 may also each include a central processing unit (CPU) that can execute instructions, for example instructions fetched by the software programs that are stored in the computer readable storage medium.

The file-searching module 510 may contain instructions that can be executed to perform the file path searching task of the block 210 of FIG. 5. The field-separation module 520 may contain instructions that can be executed to perform the field separation task of the block 220 of FIG. 5. The filing-convention-determination module 530 may contain instructions that can be executed to perform the filing convention determination task of the block 230 of FIG. 5. The filing-convention-validation module 540 may contain instructions that can be executed to perform the filing convention validation task of the blocks 240-250 of FIG. 5. The filing-convention-association module 550 may contain instructions that can be executed to perform the filing convention association task of the block 260 of FIG. 5. The file manipulation module 560 may contain instructions that can be executed to perform the file manipulation task of the block 280 of FIG. 5.

The database 420 may include storage media that can store the following:
A list of search criteria that may be used in the searching of file paths. This may be accessed by the file searching module 510.
A list of search results. This may be accessed by the file searching module 510.
A list of known fields and separators. This may be accessed by the field-separation module 520.
A list of known filing conventions. This may be accessed by the filing-convention determination module 530.
A list of fields that are associated with each filing convention. This may be accessed by the filing-convention determination module 530.
A listed of file paths that need to be associated with filing conventions. This may be accessed by the filing-convention association module 550.
All the information extracted from each file path through the execution of the method 200 (FIG. 5). This may be accessed by any of the modules 510-550.

The network 430 may include routers, repeaters, storage units, cabling, and other devices such as additional databases and additional process engines. The process engine 410 and the database 420 may be able to communicate with other devices on the network 430 and either carry out instructions received from the network, or send instructions through the network to these external devices to be carried out.

The interface 440 may include keyboards, mice, display devices (such as a monitor), or microphones, so that users 610-640 may be able to communicate with the system 400. For example, any of the users 610-640 may upload a list of files to be processed by the process engine 410, so that one or more filing conventions for that user may be determined. The users 610-640 may also be presented with a list of options to manipulate files, the list of option offered by the file manipulation module 560. The users 610-640 may select one or more of these options and input his/her selection to the file manipulation module 560, which will then carry out the tasks associated with these options accordingly.

The foregoing has outlined features of several embodiments so that those skilled in the art may better understand the detailed description that follows. The specific examples of components and arrangements described above are merely examples and are not intended to be limiting. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

From the foregoing discussions, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method, comprising:
receiving a computer file path, the file path being associated with a digital media file;
separating, by a field-separation module, the file path into a plurality of fields;
determining, by a filing-convention-determination module, a filing convention based on the fields; and
storing the filing convention in a database.

2. The method of claim 1, wherein:
the receiving comprises receiving a plurality of computer file paths that are respectively associated with a plurality of digital media files;
the separating comprises separating each of the file paths into a plurality of fields; and
the determining comprises determining a most representative filing convention as the filing convention for all of the file paths based on the respective fields associated with each file path.

3. The method of claim 2, further comprising:
before the storing, performing a validation process on the filing convention, the validation process including passing a predetermined threshold;
if the filing convention is validated, associating the validated filing convention with each of the file paths that match the validated filing convention; and
if the filing convention is not validated, repeating the separating and the determining for all the file paths to generate an additional filing convention.

4. The method of claim 3, wherein the storing the filing convention comprises storing the fields of the file path associated with the validated filing convention in a same database entry as the validated filing convention, and further comprising:
receiving a sorting request; and
sorting the digital media files in response to the sorting request, wherein the sorting is carried out using the fields that are stored in the database.

5. The method of claim 2, further comprising manipulating a subset of the digital media files, the manipulating including tasks selected from the group consisting of:
choosing the subset of digital media files based on criteria received from a user, the criteria specifying specific fields;
exporting the subset of digital media files to a social networking site;
deleting the subset of digital media files;
renaming the subset of digital media files;
adding the subset of digital media files to a library under the filing convention;
converting the subset of digital media files from a first filing convention to a second filing convention different from the first filing convention, one of the first and second filing conventions being the filing convention determined by the filing-convention-determination module; and
uploading information related to the filing convention to a server.

6. The method of claim 2, further comprising:
determining whether the filing convention matches all of the file paths; and
if the determining indicates that the filing convention does not match a subset of the file paths, repeating the separating and the determining for the subset of the file paths to generate an additional filing convention.

7. The method of claim 2, wherein the receiving carried out so that the plurality of file paths are obtained using a file-searching module that is operable to search only within a user-specified directory and to only return file paths having a user-specified file extension.

8. The method of claim 1, wherein the field-separation module and the filing-convention-determination module each include a computer hardware device encoded with software instructions.

9. The method of claim 1, further comprising providing a user with options based on the filing convention for organizing stored or subsequent digital media files.

10. An apparatus comprising a non-transitory, tangible computer readable storage medium storing a computer program, wherein the computer program has instructions that when executed, carry out:
separating a file path into a plurality of fields;
determining a filing convention based on the fields; and
storing the filing convention.

11. The apparatus of claim 10, wherein:
the computer program has a first set of additional instructions that when executed, carry out receiving a plurality of computer file paths that respectively associated with a plurality of digital media files;
the instructions for the separating comprise separating each of the file paths into a plurality of fields; and
the instructions for the determining comprise determining a most representative filing convention as the filing convention for all of the file paths based on the respective fields associated with each file path.

12. The apparatus of claim 11, wherein the computer program has a second set of additional instructions that when executed, carry out:
before the storing, performing a validation process on the filing convention, the validation process including passing a predetermined threshold;
if the filing convention is validated, associating the validated filing convention with each of the file paths that match the validated filing convention; and
if the filing convention is not validated, repeating the separating and the determining for all the file paths to generate an additional filing convention.

13. The apparatus of claim 12, wherein the instructions for the storing comprise instructions for:
storing the filing convention in a database; and
storing the fields of the file path associated with the validated filing convention in a same database entry as the validated filing convention;
and wherein the computer program has a third set of additional instructions that when executed, carry out:
receiving a sorting request; and
sorting the digital media files in response to the sorting request, wherein the sorting is carried out using the fields that are stored in the database.

14. The apparatus of claim 11, wherein the computer program has a fourth set of additional instructions that when executed, carry out manipulating a subset of the digital media files, the manipulating including tasks selected from the group consisting of:
choosing the subset of digital media files based on criteria received from a user, the criteria specifying specific fields;
exporting the subset of digital media files to a social networking site;
deleting the subset of digital media files;
renaming the subset of digital media files;
adding the subset of digital media files to a library under the filing convention;
converting the subset of digital media files from a first filing convention to a second filing convention different from the first filing convention, one of the first and second filing conventions being the filing convention determined by the filing-convention-determination module; and
uploading information related to the filing convention to a server.

15. The apparatus of claim 11, wherein the computer program has a fifth set of additional instructions that when executed, carry out:
determining whether the filing convention matches all of the file paths; and
if the determining indicates that the filing convention does not match a subset of the file paths, repeating the separating and the determining for the subset of the file paths to generate an additional filing convention.

16. The apparatus of claim 11, wherein the instructions for the receiving comprise instructions for searching only within a user-specified directory and to only return file paths having a user-specified file extension.

17. The apparatus of claim 10, wherein the instructions for the separating comprise instructions for separating two adjacent fields with a separator, and wherein:
each of the fields is selected from the group consisting of: time, day, week, month, year, date, system path, name, person, location, event, action, file prefix, file suffix, file sequence number, media type, category, caption, subject, and creator; and
the separator is a character selected from the group consisting of: forward slash, backslash, space, dot, hyphen, underscore, tilde, less than sign, greater than sign, equal sign, number sign, at sign, colon, semicolon, asterisk, and vertical bar.

18. The apparatus of claim 10, wherein the computer program has a sixth set of additional instructions that when executed, carry out providing a user with options based on the filing convention for organizing stored or subsequent digital media files.

19. A system, comprising:
a process engine that separates a file path into a plurality of fields and determines a filing convention based on the fields;
a database that stores the filing convention; and
an interface that allows the process engine to communicate with a user.

20. The system of claim 19, wherein the process engine:
identifies a plurality of computer file paths in response to user input received from the interface, the plurality of file paths being respectively associated with a plurality of digital media files;
separates each of the file paths into a plurality of fields; and
determines a most representative filing convention as the filing convention for all of the file paths based on the respective fields associated with each file path.

21. The system of claim 20, wherein the process engine performs a validation process on the filing convention before the filing convention is stored in the database, the validation process including passing a predetermined threshold; and wherein:
if the filing convention is validated, the process engine associates the validated filing convention with each of the file paths that match the validated filing convention; and
if the filing convention is not validated, the process engine separates the file paths into fields in a different manner, and determines an additional filing convention accordingly.

22. The system of claim 20, wherein the process engine determines whether the filing convention matches all of the file paths; and wherein:
if the process engine determines that the filing convention does not match a subset of the file paths, the process engines separates each of the subset of the file paths and determines an additional filing convention accordingly; and
if the process engine determines that the filing convention does match all of the file paths, the process engine:
offers a list of file manipulation options to a user;
receives input from the user; and
performs a file manipulation task in response to the input received.

23. The system of claim 19, wherein the process engine provides a user with options based on the filing convention for organizing stored or subsequent digital media files.
